(19) United States
(12) Patent Application Publication
(10) Pub. No.: US 2025/0371901 A1
(43) Pub. Date: Dec. 4, 2025

(54) MULTI-MODAL MACHINE LEARNED EMBEDDINGS AND DATA PROCESSING FRAMEWORKS FOR FUSING CROSS MODAL INSIGHTS

(71) Applicant: Optum, Inc., Minnetonka, MN (US)

(72) Inventors: Carlos W. MORATO, Sammamish, WA (US); Zahra RAJABI, Vienna, VA (US); Sanjay Kumar SINGH, Karnataka (IN); Zhili YANG, Chesterbrook, PA (US)

(21) Appl. No.: 18/733,291

(22) Filed: Jun. 4, 2024

(51) Int. Cl. G06V 30/416; G06F 40/30

(52) U.S. Cl. CPC G06V 30/416; G06F 40/30

(57) ABSTRACT

Various embodiments of the present disclosure provide an end-to-end multi-modal processing pipeline for improving computer comprehension of multi-modal documents. The techniques include extracting embedded media segments from the multi-modal document and identifying semantic section entities based on text segments within the document. The techniques include generating a multi-modal section embedding for each of the semantic section entities that fuses insights from both text and embedded media segments of the multi-modal document. The techniques include generating a multi-modal unstructured rule based on the multi-modal section embedding and then generating a multi-modal structured rule from the multi-modal unstructured rule. The performance of various prediction-based actions may be initiated based on the multi-modal structured rule.

### BACKGROUND

Various embodiments of the present disclosure address technical challenges related to natural language processing (NLP) and computer comprehension techniques for multi-modal data structures, such as documents with embedded text, images, and other expressions of information. Traditional NLP techniques are limited to the interpretation of text and fail to account for other modalities that may be embedded within data. This limits NLP to a single modality that cannot fuse information from potentially complementary insights expressed through different modalities, such as images, tables, and the like. While other data comprehension techniques exist, they are traditionally limited to a specific modality and fail to accurately fuse different modalities, such as text, images, and tables into a single, holistic data structure capable of comprehensively understanding a multi-modal data structure. These limitations prevent traditional computer comprehension techniques from understanding complex documents in which data is reflected through multiple, complementary modalities.

Various embodiments of the present disclosure make important contributions to traditional NLP and computer comprehension techniques by addressing these technical challenges, among others.

### BRIEF SUMMARY

Various embodiments of the present disclosure provide improved data processing pipelines that that enable computer comprehension of complex, multi-modal data structures. To do so, some embodiments of the present disclosure leverage a multi-stage pipeline that connects NLP, computer vision, and tabular data analysis techniques to extract and fuse information from a multi-modal document into a set of multi-modal structured rules. The multi-stage pipeline may leverage a multi-modal embedding model architecture to encode contextual information from each of the modalities to improve a computer's understanding of a multi-modal document. The multi-modal embedding model may generate a multi-modal document embedding using features engineered from content expressed across a plurality of different modalities. In this way, context expressed across different modalities may be embedded into a shared embedding space. By doing so, different modalities of information may be aligned in accordance with their semantic similarity. Once aligned, the information may be fused to generate a holistic understanding of a topic expressed by a multi-modal data structure. In this way, some of the techniques of the present disclosure may automate the generation of multi-modal structured rules from a variety of complex multi-modal data structures in which information may be expressed in different modalities and unconventional formats.

In some embodiments, a computer-implemented method includes identifying, by one or more processors and using a natural language processing model, a plurality of semantic section entities from a multi-modal document based on one or more text segments within the multi-modal document; identifying, by the one or more processors, one or more embedded media segments from the multi-modal document; generating, by the one or more processors, a multi-modal section embedding for a semantic section entity of the plurality of semantic section entities based on the one or more embedded media segments and the one or more text segments; generating, by the one or more processors and using a large language model, a multi-modal unstructured rule based on the multi-modal section embedding; generating, by the one or more processors and using the large language model, a multi-modal structured rule from the multi-modal unstructured rule; and initiating, by the or more processors, the performance of a prediction-based action based on the multi-modal structured rule.

In some embodiments, a computing system includes memory and one or more processors communicatively coupled to the memory and the one or more processors are configured to identify, using a natural language processing model, a plurality of semantic section entities from a multi-modal document based on one or more text segments within the multi-modal document; identify one or more embedded media segments from the multi-modal document; generate a multi-modal section embedding for a semantic section entity of the plurality of semantic section entities based on the one or more embedded media segments and the one or more text segments; generate, using a large language model, a multi-modal unstructured rule based on the multi-modal section embedding; generate, using the large language model, a multi-modal structured rule from the multi-modal unstructured rule; and initiate the performance of a prediction-based action based on the multi-modal structured rule.

In some embodiments, one or more non-transitory computer-readable storage media includes instructions that, when executed by one or more processors, cause the one or more processors to identify, using a natural language processing model, a plurality of semantic section entities from a multi-modal document based on one or more text segments within the multi-modal document; identify one or more embedded media segments from the multi-modal document; generate a multi-modal section embedding for a semantic section entity of the plurality of semantic section entities based on the one or more embedded media segments and the one or more text segments; generate, using a large language model, a multi-modal unstructured rule based on the multi-modal section embedding; generate, using the large language model, a multi-modal structured rule from the multi-modal unstructured rule; and initiate the performance of a prediction-based action based on the multi-modal structured rule.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a dataflow diagram showing example data structures and modules of an automated, end-to-end, multi-modal data processing pipeline for fusing multi-modal information into holistic data structures in accordance with some embodiments discussed herein.

FIG. 5 is a dataflow diagram showing example data structures and modules of a multi-stage feature engineering and embedding pipeline for a multi-modal embedding model in accordance with some embodiments discussed herein.

FIG. 6 is an operational example of an embedded media segment and corresponding textual media description in accordance with some embodiments discussed herein.

FIG. 7 is an operational example of a multi-modal embedding model architecture in accordance with some embodiments discussed herein.

FIG. 8 is operational example of a multi-modal section embedding in accordance with some embodiments discussed herein.

FIG. 9 is operational example of the automated, end-to-end, multi-modal, data processing pipeline in accordance with some embodiments discussed herein.

FIG. 10 is a flowchart diagram of an example process for automatically fusing multi-modal data into a comprehensive set of structured rules in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

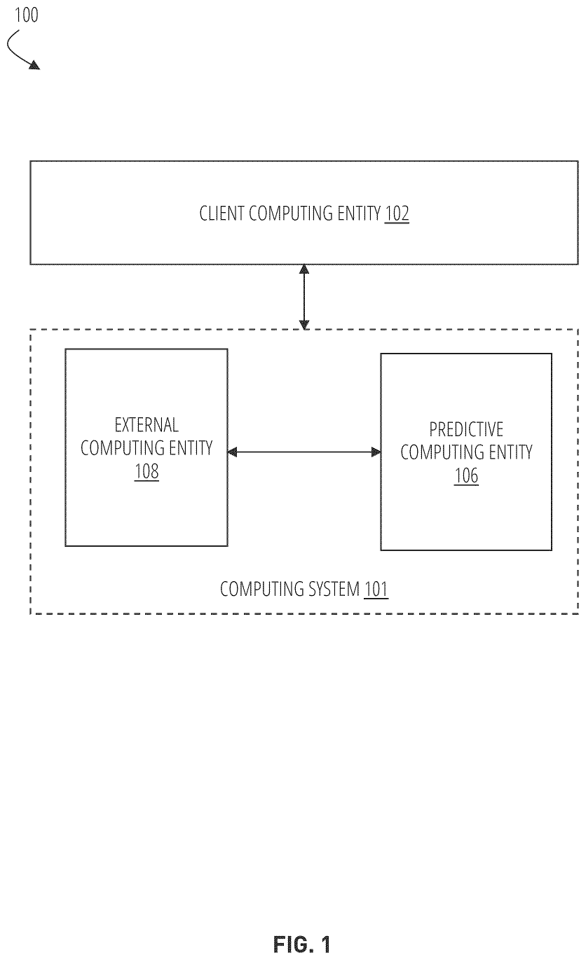

FIG. 1 provides an example overview of an architecture 100 in accordance with some embodiments of the present disclosure. The architecture 100 includes a computing system 101 configured to receive request, such as generative text requests, from client computing entities 102, process the requests to generate generative text outputs, and provide the generated text outputs to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, one or more machine learning models may be trained to generate embeddings, such as multi-modal embeddings, and/or the like, generative text in various forms, such as generative model prompts, textual media descriptions, multi-modal unstructured/structure rules, and/or the like. The models may form a machine learning pipeline that may be configured to automatically generate one or more multi-modal structured rules from a particular multi-modal document and then leverage the one or more multi-modal structured rules to perform a prediction-based action. This technique will lead to more accurate and reliable data processing techniques that may be efficiently used for a diverse set of different use cases.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive requests from client computing entities 102, process the requests to generate outputs, such as multi-modal structure rules, and/or the like, and provide the generated outputs to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., generative text techniques, embedding techniques, and/or the like) described herein. The external computing entities 108, for example, may include and/or be associated with one or more entities that may be configured to receive, transmit, store, manage, and/or facilitate datasets, such as the example template data store, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

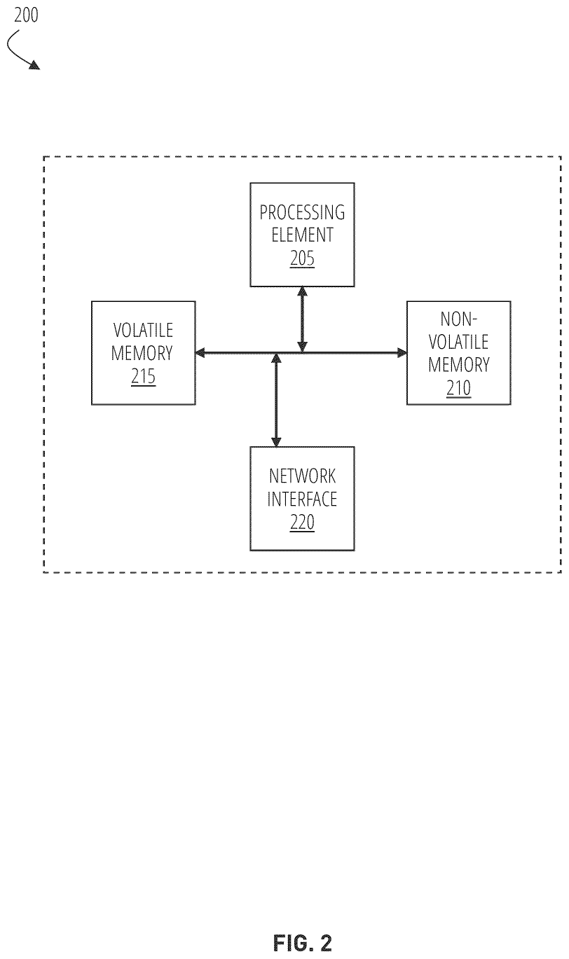

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

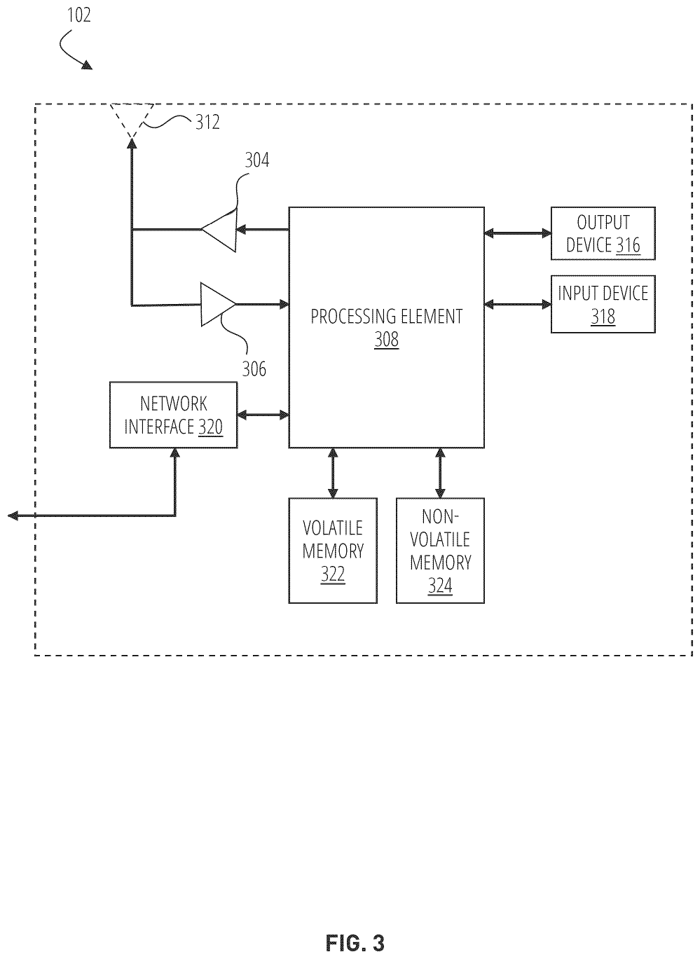

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. Examples of Certain Terms

In some embodiments, the term “multi-modal document” refers to a data entity that describes a reference document for a prediction domain. A multi-modal document, for example, may represent information for a prediction domain in one or more different modalities, such as a text modality, a media modality, a graphical modality, and/or the like. In some examples, the variety of modalities may contain text, images, tables, and/or other graphical elements that may cross-reference, build upon, and/or otherwise relate to one another to provide complementary information for a predictive domain. As described herein, the combination of modalities may help simplify information for a human, while presenting complex computer interpretation challenges for extracting and interpreting the semantic meaning and relationships between different components of the multi-modal document. By way of example, a multi-modal document may include one or more text segments and/or one or more embedded media segments that complement the one or more text segments. Each of these segments may be traditionally interpreted using techniques tailored to the format of the segment without consideration of complementing segments of different modalities that may modify, augment, and/or otherwise change a semantic meaning of the segment.

A multi-modal document may include a document that is manually created, reviewed, and/or otherwise verified as an exemplary document for a particular topic, scenario, and/or circumstance. For instance, a multi-modal document may include a guideline document outlining one or more guidelines for completing a particular task. A multi-modal document may include any type of document (e.g., any combination of text segments, templates, subject matter, etc.) and may be tailored to the subject matter of a particular prediction domain. As one example, for a healthcare prediction domain, a multi-modal document may include a healthcare guideline that is published as a combination of textual descriptions and accompanying images within a portable document format (PDF). The technical challenge in understanding such healthcare guidelines lies in the variety of formats that healthcare guidelines can use to describe a particular task. For example, healthcare guidelines may contain text, images, tables, and/or other graphical elements that may be arranged in complex formatting and hierarchical arrangements to simplify human comprehension at the expense of computer interpretability.

In some embodiments, the term “text segment” refers to a text-based component of a multi-modal document. A text segment, for example, may include one or more characters, words, sentences, and/or the like that are arranged in a textual format. A text segment may include a title, a paragraph, and/or other textual descriptions within a multi-modal document. Each text segment may include structured text and/or natural language text.

In some embodiments, the term “semantic section entity” refers to a semantically connected portion of a multi-modal document. A semantic section entity, for example, may include a standalone section of content (e.g., text, media, etc.) within the multi-modal document. For instance, a semantic section entity may correspond to an individual topic within a multi-modal document. The topic, for example, may correspond to a section title and/or another header or section identifier within the multi-modal document.

In some embodiments, a multi-modal document defines a hierarchical relationship between one or more semantic section entities within the multi-modal document. A semantic section entity may be identified by identifying the hierarchy relationships between different components of the multi-modal document. In some examples, the hierarchy relationships may be identified based on one or more text segments within the multi-modal document. For example, the one or more text segments may be parsed into the semantic section entities in accordance with a rules-based approach, including the following steps:

```
Step 1: Page separation
  Collection of pages [P₁,P₂,..,Pₙ] = pdf_Reader(Doc)
Step 2: Text detection
  For Pᵢ in [P₁,P₂,..,Pₙ]:
    Text blocks [B₁,B₂,..,Bₙ] = get_Text_Dict(Pᵢ,)[“blocks”]
Step 3: Section separation by format analysis
  # iterate through the text blocks
  For Bᵢ in Text blocks [B₁,B₂,..,Bₙ]:
    # block contains text
    If type(Bᵢ) == Text:
      # iterate through the text lines
      For Lᵢ in Bᵢ[lines]:
        # iterate through the text spans
          For Sᵢ in Lᵢ[spans]:
            # identify size, flags, font, color
            Style = “{0}_{1}_{2}_{3}”.format(Sᵢ[‘size’], Sᵢ[‘flags’],
            Sᵢ[‘font’], Sᵢ[‘color’])
  # Generate text dictionary with font size as key and style tags as value
  For Pᵢ in [P₁,P₂,..,Pₙ]:
    For Bᵢ in Text blocks [B₁,B₂,..,Bₙ]:
      For Lᵢ in Bᵢ[lines]:
        For Sᵢ in Lᵢ[spans]
          if Sᵢ[‘style’] == previous_Sᵢ[‘style’]:
            # in the same block, so concatenate strings
            Block_string += “ ” +Sᵢ[‘text’]
          Else:
            # new block started
            Block_string = “”
Step 4: Semantic merging for the sections in adjacent pages
  The section separation in Step 3 could not identify sections in the two adjacent pages.
  If Similarity (Sₙ in Pⱼ₋₁, S₁in Pⱼ):
    Merge(Sₙ in Pⱼ₋₁, S₁in Pⱼ)
Step 5: Content filtering
  Not all the sections in medicine documents have valid healthcare guideline. For example,
  there are sections of “Introduction” and “Conclusion” in most of the publications. These
  sections are lack of specifications which should be filtered out for guideline generation.
  For Sᵢ in [S₁,S₂,..Sₙ]:
    If isGuidelineSection(Sᵢ):
      Res.append(Sᵢ)
```

In some embodiments, the term “embedded media segment” refers to a media-based component of a multi-modal document. An embedded media segment, for example, may include media content embedded within and/or between one or more text segments of a multi-modal document. An embedded media segment may include any type of media content, including images, audio, tables, flowcharts, and/or the like. In some examples, an embedded media segment may be extracted from a multi-modal document using one or more media extraction techniques, such as Optical Character Recognition Feeder (OCRFeeder), Tesseract, layout parse, and/or the like. As one example, an image, table, and/or the like may be extracted by applying layout parse to identify the media content region in the multi-modal document, extracting the media content region, and then storing the extracted content as an embedded media segment.

In some embodiments, the term “multi-modal section embedding” refers to an encoded vector that describes one or more text segments and embedded media segments within a semantic section entity. A multi-modal section embedding may be generated by aligning (e.g., through a multi-modal alignment technique) one or more co-learned embedding representations respectively associated with one or more text segments and embedded media segments that are semantically similar to a topic of a semantic section entity. For example, a multi-modal section embedding may be generated by identifying one or more co-learned embedding representations based on an embedding comparison between a plurality of co-learned embedding representations of a multi-modal document embedding and a topic embedding of the semantic section entity. By way of example, a multi-modal section embedding may be generated for each semantic section entity of a plurality of semantic section entities within a multi-modal document using a cross-modal retrieval approach in which (i) a topic similarity score is generated for each of a plurality of co-learned embedding representations based on a comparison between a topic embedding and a respective co-learned embedding representation and (ii) one or more co-learned embedding representations are identified based on a comparison between the topic similarity scores and a similarity threshold. By way of example, a plurality of multi-modal section embeddings may be generated for the multi-modal document based on the following operations:

For each Section:
Similarity_Rank (Embedding model (section topic (title)), Multimodal document embedding)
[section topic, text segment, embedded media segment]=similarity threshold (topic similarity score)

In some examples, the similarity threshold may include a hyperparameter (e.g., 0.5, 0.7) that may be optimized for a particular task based on historical performance metrics. In this manner, one or more co-learned embedding representations may be extracted from a multi-modal document embedding to generate a multi-modal section embedding for a semantic section entity of the multi-modal document.

In some embodiments, the term “multi-modal document embedding” refers to a plurality of co-learned embedding representations for a multi-modal document. For example, a multi-modal document embedding may describe a common embedding space for each of the segments of a multi-modal document. The multi-modal document embedding, for example, may include a co-learned embedding representation for each text segment and/or embedded media segment within the multi-modal document. In some examples, the multi-modal document embedding may be generated by applying a multi-modal embedding model to a plurality of text and media features of the plurality of text and embedded media segments, such that: multi-modal document embedding=multi-modal embedding modal (text features, media features).

In some embodiments, the term “co-learned embedding representation” refers to an encoded vector that describes a segment of a multi-modal document. A co-learned embedding representation may be generated for a text segment and/or an embedded media segment. Each co-learned embedding representation may be generated based on one or more segment features. For instance, a co-learned embedding representation for a text segment may be generated by inputting one or more text features to a multi-modal embedding model. In addition, or alternatively, a co-learned embedding representation for an embedded media segment may be generated by inputting one or more media feature to a multi-modal embedding model.

In some embodiments, the term “multi-modal embedding model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A multi-modal embedding model may include any type of model configured, trained, and/or the like to generate an intermediate output, such as a feature embedding, for a text segment, embedded media segment, and/or the like. A multi-modal embedding model may include one or more of any type of machine learning model including one or more supervised, unsupervised, semi-supervised, reinforcement learning models, and/or the like. For instance, a multi-modal embedding model may include a bidirectional transformer that may be configured for multi-modal data. For example, the multi-modal embedding model may include a dual channel, multi-layered, neural network with a shared transformer layer. The shared transformer layer may share attention weights between intermediate representations of different modalities. In this manner, the multi-modal embedding model may generate co-learned embedding representations for both text and embedded media segments within a shared embedding space. In some examples, the multi-modal embedding model may be trained based on domain specific data. For example, the multi-modal embedding model may be trained, using one or more machine learning training techniques (e.g., back-propagation of errors, gradient decent, etc.), over a domain-specific, multi-modal training dataset (e.g., a clinical dataset for a clinical domain, etc.) that includes a plurality of training multi-modal documents for a particular domain.

In some embodiments, the term “text feature” refers to a predictive characteristic of a text segment. A text feature, for example, may include one or more text attributes and/or an enriched text segment for a text segment. In some examples, a plurality of text features may be encoded to generate a co-learned embedding representation for a text segment.

In some embodiments, the term “text attribute” refers to a data entity that describes an observation for a text segment. A text attribute, for example, may include the content (e.g., a sequence of characters, words, sentences, etc.) of the text segment and/or one or more contextual observations, such as a page index, a location, a section title, a document title, and/or the like. By way of example, a text attribute for a text segment may include (i) a content attribute that identifies textual content of the text segment, (ii) a page index attribute that identifies a page of the multi-modal document from which the text segment is extracted, (iii) a location attribute that identifies a relative location within a page of the multi-modal document from which the text segment is extracted, (iv) a section title attribute that identifies a title of a semantic section entity that corresponds to the text segment, (v) a document title of the multi-modal document, and/or the like.

In some embodiments, the term “enriched text segment” refers to a modified text segment that is modified to standardize and emphasize one or more terms within the text segment that are predictive within a prediction domain. In some examples, an enriched text segment is generated using a natural language technique, such as a named entity recognition (NER) model, which is configured for a particular prediction domain. As one example, in a clinical prediction domain, an enriched text segment may include one or more standardized clinical codes (e.g., International Statistical Classification of Diseases (ICD) codes, Current Procedural Terminology (CPT) codes, RxNorm codes, etc.). In some examples, an enriched text segment is generated using an NER model that is trained to classify the text segment with one or more clinical codes based on the content of the text segment.

In some embodiments, the term “named entity recognition model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A NER model may include any type of model configured, trained, and/or the like to classify text with respect to a particular prediction domain, as described herein. For example, the NER model may include an NLP technique, such as a machine learning model that is trained to generate a class, from a multi-class prediction space, for a text segment. By way of example, a clinical NER model may include a machine learning model configured to identify and extract named entities such as diseases, medications, medical procedures, and/or the like from unstructured healthcare documents. In this manner, the process of extracting and standardizing key medical entities may be automated to help the clustering of multimodal inputs and knowledge fusion.

In some embodiments, the term “media feature” refers to a predictive characteristic of an embedded media segment. A media feature, for example, may include one or more media attributes and/or a textual media description for embedded media segments. In some examples, a plurality of media features may be encoded to generate a co-learned embedding representation for an embedded media segment.

In some embodiments, the term “media attributes” refers to a data entity that describes an observation for an embedded media segment. A media attribute, for example, may include the content (e.g., an image representation, etc.) of an embedded media segment and/or one or more contextual observations, such as a page index, a location, a title, a document title, and/or the like. By way of example, a media attribute for an embedded media segment may include (i) a content index attribute that identifies a location of an embedded media segment extracted from a multi-modal document, (ii) a page index attribute that identifies a page of the multi-modal document from which the embedded media segment is extracted, (iii) a location attribute that identifies a relative location within a page of the multi-modal document from which the embedded media segment is extracted, (iv) a media title attribute that identifies a textual title of the embedded media segment, (v) a document title of the multi-modal document, and/or the like.

In some embodiments, the term “textual media description” refers to generative text for an embedding media segment. A textual media description, for example, may include one or more media text segments that describe, in text, an embedding media segment. In some examples, a textual media description may be generated by inputting the embedded media segment to a generative model that is configured to transfer the embedded media segment to a text description.

In some embodiments, the term “generative model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A generative model may include any type of model configured, trained, and/or the like to generate natural language text from media, such as an embedded media segment, as described herein. For example, the generative model may include a large language model (LLM), such as a generative pre-trained transformer (GPT) model. In some examples, the generative model may include a GPT-4 with vision model and/or any other machine learning model with multimodal capabilities.

In some embodiments, the term “topic embedding” refers to an encoded vector that describes a semantic section entity. In some examples, a topic embedding may include an embedding vector that is generated, using a multi-modal embedding model, based on one or more attributes of a semantic section entity. By way of example, a topic embedding may include an embedding vector of a section title corresponding to the semantic section entity. For instance, a topic embedding may be generated by identifying a section title (e.g., based on a formatting, location, and/or the like of a text segment within the semantic section entity, etc.) for a semantic section entity and inputting the section title to a multi-modal embedding model, as described herein.

In some embodiments, the term “topic similarity score” refers to a metric that is reflective of a semantic similarity between a semantic section entity and a segment (e.g., text segment, embedded media segment, etc.) of a multi-modal document. In some examples, a topic similarity score for a particular segment may be based on a comparison between a co-learned embedding representation for the particular segment and a topic embedding for a semantic section entity. For example, a topic similarity score may include an embedding-based distance metric, such as a cosine distance, and/or the like. In some examples, a plurality of segments from a multi-modal document may be matched to a semantic section entity by ranking the similarities scores across each of the segments with respect to the semantic section entity. As described herein, the plurality of segments may be leveraged to generate a multi-modal unstructured rule corresponding to the semantic section entity that fuses knowledge across multiple information modalities. For instance, the unstructured rule may be generated by applying an LLM to an unstructured rule model prompt.

In some embodiments, the term “unstructured rule model prompt” refers to a generative model prompt for instructing an LLM to generate a multi-modal unstructured rule. In some examples, an unstructured rule model prompt may define rule criteria for a multi-modal unstructured rule, such as a character limit, a rule format, and/or the like. In some examples, the unstructured rule model prompt may include one or more prompt fields. The one or more prompt fields may include an instruction field comprising a natural language set of instructions for generating a multi-modal unstructured rule based on a second field. The second field may include a context field that provides content for generating the multi-modal unstructured rule in accordance with the set of instructions. In some examples, the context field may include an enriched text segment and a textual media description for each segment of the multi-modal document that corresponds to a particular semantic section entity.

In some embodiments, the term “LLM” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The LLM may include any type of model configured, trained, and/or the like to generate natural language text in response to a textual prompt, such as an unstructured rule model prompt, a structured rule model prompt, and/or the like. The LLM, for example, may include any type of LLM, such as a generative pre-trained transformer, and/or the like.

In some embodiments, the term “multi-modal unstructured rule” refers to a sequence of natural language text that is output from an LLM in response to an unstructured rule model prompt. The natural language text, for example, may summarize one or more portions of a context field in accordance with a natural language set of instructions.

In some embodiments, the term “structured rule model prompt” refers to a generative model prompt for instructing an LLM to generate a multi-modal structured rule. In some examples, a structured rule model prompt may define rule criteria for a multi-modal structured rule, such as a character limit, a rule format, one or more structured fields, a structured field hierarchy (e.g., a decision tree structure, etc.), and/or the like. In some examples, the structured rule model prompt may include one or more prompt fields. The one or more prompt fields may include an instruction field comprising a natural language set of instructions for generating a multi-modal structured rule based on a second field and third field. The second field may include a context field that provides content for generating the multi-modal unstructured rule in accordance with the set of instructions. In some examples, the context field may include a multi-modal unstructured rule for a particular semantic section entity.

In some embodiments, a third field include one or more prompt examples. For instance, a structured rule model prompt may include a few shot prompt that includes one or prompt examples that reflect ground truth outputs for an LLM. The one or more prompt examples may include one or more related prompt examples from an example template data store that correspond to the multi-modal unstructured rule for a particular semantic section entity.

In some embodiments, the term “related prompt example” refers to a ground truth multi-modal structured rule for an LLM. A related prompt example, for instance, may include a historical multi-modal structured rule, a manually generated multi-modal structured rule, a verified multi-modal structured rule, and/or the like that is reflective of a desired format for a multi-modal structured rule generated in accordance with a structured rule model prompt. In some examples, a related prompt example may be selected from an example template data store based on a semantic similarity between the related prompt example and a multi-modal unstructured rule. By way of example, a related prompt example may be selected based on an embedding distance (e.g., cosine distance, etc.) between an example embedding and a multi-modal unstructured rule. In some examples, a threshold number (e.g., five, ten, twenty, etc.) of related prompt examples may be selected from the example template data store based on the semantic similarity between a multi-modal unstructured rule and a plurality of candidate prompt examples of the example template data store.

In some embodiments, the term “example template data store” refers to a data structure that describes a plurality of related prompt examples for a prediction domain. An example template data store may include any type (and any number) of data storage structures including, as examples, one or more linked lists, databases (e.g., relational databases, graph database, etc.), and/or the like. In some embodiments, an example template data store may include a plurality of candidate prompt examples, each reflective of a ground truth example for a multi-modal structured rule. The plurality of candidate prompt examples may include historical multi-modal structured rules, manually generated and/or verified multi-modal structured rules, and/or the like.

In some embodiments, the term “multi-modal structured rule” refers to a text-based data structure that is output from an LLM in response to a structured rule model prompt. The text-based data structure, for example, may include a structured rule set derived from a semantic section entity of a multi-modal document. By way of example, a text-based data structure may include a plurality of related rules that are arranged in accordance with a decision logic to improve both computer and human interpretability of a multi-modal unstructured rule. As examples, a multi-modal structured rule may include a rule-based questionnaire, a decision tree logic, and/or the like that may be interacted with to provided actionable insights (e.g., binary insights, probabilities, etc.) for a particular task. In this manner, using some of the techniques of the present disclosure, the combined power of multimodal and generation capabilities may be leveraged to provide an end-to-end solution which includes both (i) understanding unstructured and complementary multi-modal content, such as traditional medical guideline documentation and (ii) distilling structured rules from the unstructured and complementary multi-modal content to improve computer comprehension for downstream tasks.

### IV. Overview

Various embodiments of the present disclosure provide data processing techniques that improve traditional computer comprehension capabilities, such as those traditionally leveraged to interpret text, media, and other information mediums. To do so, some embodiments of the present disclosure provide a data processing framework including multiple, sequential stages that collectively extract information from multi-modal data structures, generate modality-specific features for the extracted information, embed the features to a shared embedding space, and leverage the shared embedding space to fuse information across different modalities into a holistic, computer-interpretable data structure. To do so, the data processing framework may leverage a multi-stage data processing pipeline with a multi-modal embedding model. The multi-stage data processing pipeline may pre-process information from a multi-modal data structure to extract modality specific features for the multi-modal embedding model. Using these features, the multi-modal embedding model may encode information expressed as different, traditionally incompatible modalities, into a shared embedding space. The multi-stage data processing pipeline may then post-process the shared embedding space to fuse semantically similar insights from across a plurality of modalities and, using these insights, generate computer interpretable data structures that comprehensively account for the information expressed in the original, non-interpretable multi-modal data structure. By doing so, some of the techniques of the present disclosure improves computer comprehension techniques to directly address technical challenges within the realm of computer-based data comprehension, such as multi-modal information sharing, among others.

In various embodiments, some of the techniques of the present disclosure provide a multi-stage data processing pipeline that enables improved computer comprehension with respect to multi-modal data structures. As described herein, the multi-stage data processing pipeline provides feature engineering and model output processing capabilities that enable the use of a multi-modal embedding model with a plurality of different modalities. The feature engineering capabilities, for example, leverage a particular configuration of machine-learning models to generate targeted features from traditionally incompatible modalities. The targeted features may include textual media descriptions for embedded media segments, enriched text segments for text segments, and/or other features that may be encoded by a multi-modal embedding model to a shared embedding space. In this way, a multi-modal embedding model may be configured to generate co-learned embedding representations from the engineered features that allow for an identification of semantically similar content regardless of a modality in which the content is expressed.

In various embodiments, some of the techniques of the present disclosure provide a multi-modal embedding model architecture that enables the generation of co-learned embedding representations of data expressed across different, traditionally incompatible modalities. The multi-modal embedding model architecture, for example, may include a dual channel, multi-layered, embedding and transformer architecture with a shared attention layer to share attention weights across different modalities of information. For instance, a first channel of the multi-modal embedding model architecture may be configured to generate an embedding from an embedded media segment and a second channel may be configured to generate an embedding from a text segment. By including a shared attention layer, the multi-modal embedding model architecture enables weight sharing across modalities during the embedding process. In this way, a multi-modal embedding model may fuse insights from across a plurality of different embeddings into a shared, multi-modal embedding space.

In various embodiments, the multi-stage data processing pipeline of the present disclosure provides model output processing capabilities that enable the generation of computer interpretable data structures, such as multi-modal structured rules, from traditionally incompatible data sets. For example, the multi-stage data processing pipeline may leverage prompt engineering techniques and a sequence of connected LLMs to generate multi-modal structured rules using the outputs of the multi-modal embedding model. In this way, the multi-stage data processing pipeline may automatically generate computer-interpretable data structures that may be leveraged by downstream tasks to perform various actions in accordance withs traditionally uninterpretable data structures.

Examples of technologically advantageous embodiments of the present disclosure include: (i) feature engineering techniques for processing multi-modal information, (ii) multi-modal embedding models for fusing multi-modal information into a shared embedding space, and (iii) prompt engineering techniques for generating computer interpretable data structures from a shared embedding space among other aspects of the present disclosure. Other technical improvements and advantages may be realized by one of ordinary skill in the art.

### V. Example System Operations

As indicated, various embodiments of the present disclosure make important technical contributions to data processing techniques. In particular, systems and methods are disclosed herein that implement data processing frameworks to improve computer comprehension of multi-modal data structures. By doing so, complex, multi-modal data structures may be converted to multi-modal structured rules that may be interpretable to various downstream computing tasks. This, in turn, may enable the performance of computing tasks in compliance with multi-modal data structures that are traditionally uninterpretable to such tasks.

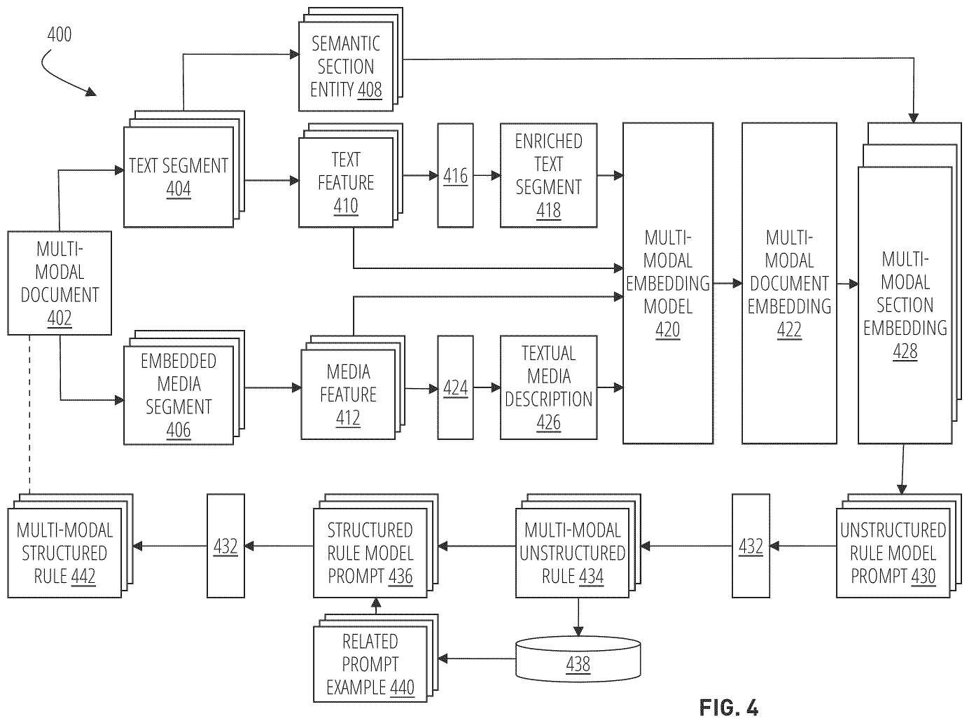

FIG. 4 is a dataflow diagram 400 showing example data structures and modules of an automated, end-to-end, multi-modal data processing pipeline for fusing multi-modal information into holistic data structures in accordance with some embodiments discussed herein. The dataflow diagram 400, for example, illustrates a multi-stage processing pipeline for extracting text segments 404 and embedded media segments 406 from a multi-modal document 402. Using some of the techniques of the present disclosure, the text segments 404 and the embedded media segments 406 may be processed individually and jointly to interpret and then fuse the information into a set of multi-modal structured rules 442. By doing so, the multi-stage processing pipeline addresses significant technical challenges with state-of-the-art document processing techniques that are traditionally unable to efficiently and accurately fuse information from across a plurality of different data modality. This allows for improved computer interpretation of complex documents and enables automated document processing pipelines for generating structured rules from both text and other modalities represented by a single document. As described herein, once generated, the multi-modal structured rules 442 may facilitate downstream computer tasks by providing computer interpretable instructions sets to downstream processes.

In some embodiments, one or more text segments 404 and one or more embedded media segments 406 are identified from the multi-modal document 402. In some examples, the text segments 404 may include portions of text within the multi-modal document 402 that form a section within the multi-modal document 402. In some examples, the one or more embedded media segments 406 may include one or more of an image data structure, a table data structure, and/or an audio data structure within one or more sections of the multi-modal document 402.

In some embodiments, the multi-modal document 402 is a data entity that describes a reference document for a prediction domain. A multi-modal document 402, for example, may represent information for a prediction domain in a plurality of different modalities, such as a text modality, a media modality, a graphical modality, and/or the like. In some examples, the variety of modalities may contain text, images, tables, and/or other graphical elements that may cross-reference, build upon, and/or otherwise relate to one another to provide complementary information for a predictive domain. As described herein, the combination of modalities may help simplify information for a human, while presenting complex computer interpretation challenges for extracting and interpreting the semantic meaning and relationships between different components of the multi-modal document 402. By way of example, a multi-modal document 402 may include one or more text segments 404 and/or one or more embedded media segments 406 that complement the one or more text segments 404. Each of these segments may be traditionally interpreted using techniques tailored to the format of the segment without consideration of complementing segments of different modalities that may modify, augment, and/or otherwise change a semantic meaning of the segment.

The multi-modal document 402 may include a document that is manually created, reviewed, and/or otherwise verified as an exemplary document for a particular topic, scenario, and/or circumstance. For instance, the multi-modal document 402 may include a guideline document outlining one or more guidelines for completing a particular task. The multi-modal document 402 may include any type of document (e.g., any combination of text segments, templates, subject matter, etc.) and may be tailored to the subject matter of a particular prediction domain. As one example, for a healthcare prediction domain, the multi-modal document 402 may include a healthcare guideline that is published as a combination of textual descriptions and accompanying images within a PDF. The technical challenge in understanding such healthcare guidelines lies in the variety of formats that healthcare guidelines can use to describe a particular task. For example, healthcare guidelines may contain text, images, tables, and/or other graphical elements that may be arranged in complex formatting and hierarchical arrangements to simplify human comprehension at the expense of computer interpretability.

In some embodiments, a text segment is a text-based component of a multi-modal document 402. A text segment, for example, may include one or more characters, words, sentences, and/or the like that are arranged in a textual format. A text segment may include a title, a paragraph, and/or other textual descriptions within the multi-modal document 402. Each text segment may include structured text and/or natural language text.

In some embodiments, the embedded media segment is a media-based component of a multi-modal document 402. An embedded media segment, for example, may include media content embedded within and/or between one or more text segments 404 of the multi-modal document 402. An embedded media segment may include any type of media content, including images, audio, tables, flowcharts, and/or the like. In some examples, an embedded media segment may be extracted from the multi-modal document 402 using one or more media extraction techniques, such as Optical Character Recognition Feeder (OCRFeeder), Tesseract, layout parse, and/or the like. As one example, an image, table, and/or the like may be extracted by applying layout parse to identify the media content region in the multi-modal document 402, extracting the media content region, and then storing the extracted content as an embedded media segment.

In some embodiments, a plurality of semantic section entities 408 are identified from the multi-modal document 402 based on one or more text segments 404 within the multi-modal document 402. For example, each semantic section entity of the plurality of semantic section entities 408 may be identified using an NLP model configured to recognize a hierarchical structure of the multi-modal document 402.

In some embodiments, a semantic section entity is a semantically connected portion of a multi-modal document 402. A semantic section entity, for example, may include a standalone section of content (e.g., text, media, etc.) within the multi-modal document 402. For instance, a semantic section entity may correspond to an individual topic within the multi-modal document 402. The topic, for example, may correspond to a section title and/or another header or section identifier within the multi-modal document 402.

In some embodiments, the multi-modal document defines a hierarchical relationship between one or more semantic section entities 408 within the multi-modal document 402. A semantic section entity may be identified by identifying the hierarchy relationships between different components of the multi-modal document. In some examples, the hierarchy relationships may be identified based on one or more text segments 404 within the multi-modal document 402. For example, the one or more text segments 404 may be parsed into the semantic section entities 408 in accordance with a rules-based approach, including the following steps:

```
Step 1: Page separation
  Collection of pages [P₁,P₂,..,Pₙ] = pdf_Reader(Doc)
Step 2: Text detection
  For Pᵢ in [P₁,P₂,..,Pₙ]:
    Text blocks [B₁,B₂,..,Bₙ] = get_Text_Dict(Pᵢ,)[“blocks”]
Step 3: Section separation by format analysis
  # iterate through the text blocks
  For Bᵢ in Text blocks [B₁,B₂,..,Bₙ]:
    # block contains text
    If type(Bᵢ) == Text:
      # iterate through the text lines
      For Lᵢ in Bᵢ[lines]:
        # iterate through the text spans
          For Sᵢ in Lᵢ[spans]:
            # identify size, flags, font, color
            Style = “{0}_{1}_{2}_{3}”.format(Sᵢ[‘size’], Sᵢ[‘flags’],
            Sᵢ[‘font’], Sᵢ[‘color’])
  # Generate text dictionary with font size as key and style tags as value
  For Pᵢ in [P₁,P₂,..,Pₙ]:
    For Bᵢ in Text blocks [B₁,B₂,..,Bₙ]:
      For Lᵢ in Bᵢ[lines]:
        For Sᵢ in Lᵢ[spans]
          if Sᵢ[‘style’] == previous_Sᵢ[‘style’]:
            # in the same block, so concatenate strings
            Block_string += “ ” +Sᵢ[‘text’]
          Else:
            # new block started
            Block_string = “”
Step 4: Semantic merging for the sections in adjacent pages
  The section separation in Step 3 could not identify sections in the two adjacent pages.
  If Similarity (Sₙ in Pⱼ₋₁, S₁in Pⱼ):
    Merge(Sₙ in Pⱼ₋₁, S₁in Pⱼ)
Step 5: Content filtering
  Not all the sections in medicine documents have valid healthcare guideline. For example,
  there are sections of “Introduction” and “Conclusion” in most of the publications. These
  sections are lack of specifications which should be filtered out for guideline generation.
  For Sᵢ in [S₁,S₂,..Sₙ]:
    If isGuidelineSection(Sᵢ):
      Res.append(Sᵢ)
```

In some embodiments, a multi-modal section embedding 428 is generated for a semantic section entity of the plurality of semantic section entities 408 based on the one or more embedded media segments 406 and the one or more text segments 404.

In some embodiments, a multi-modal section embedding is an encoded vector that describes one or more of the text segments 404 and embedded media segments 406 within a semantic section entity. A multi-modal section embedding may be generated by aligning (e.g., through a multi-modal alignment technique) one or more co-learned embedding representations respectively associated with one or more text segments 404 and embedded media segments 406 that are semantically similar to a topic of a semantic section entity. For example, a multi-modal section embedding may be generated by identifying one or more co-learned embedding representations based on an embedding comparison between a plurality of co-learned embedding representations of a multi-modal document embedding 422 and a topic embedding of the semantic section entity. By way of example, a multi-modal section embedding may be generated for each semantic section entity of a plurality of semantic section entities 408 within the multi-modal document 402 using a cross-modal retrieval approach in which (i) a topic similarity score is generated for each of a plurality of co-learned embedding representations based on a comparison between a topic embedding and a respective co-learned embedding representation and (ii) one or more co-learned embedding representations are identified based on a comparison between the topic similarity scores and a similarity threshold. By way of example, a plurality of multi-modal section embeddings 428 may be generated for the multi-modal document 402 based on the following operations:

For each Section:
Similarity_Rank (Embedding model (section topic (title)), Multimodal document embedding)
[section topic, text segment, embedded media segment]=similarity threshold (topic similarity score)

In some examples, the similarity threshold may include a hyperparameter (e.g., 0.5, 0.7) that may be optimized for a particular task based on historical performance metrics. In this manner, one or more co-learned embedding representations may be extracted from the multi-modal document embedding 422 to generate a multi-modal section embedding for a semantic section entity of the multi-modal document 402.

In some embodiments, the multi-modal section embedding 428 is generated using a plurality of text features 410 and media features 412 engineered from the one or more text segments 404 and embedded media segments 406. For example, a multi-modal document embedding 422 may be generated, using a multi-modal embedding model 420, based on a plurality of text features 410 for each of the one or more text segments 404 and a plurality of media features 412 for each of the one or more embedded media segments 406. The multi-modal section embedding 428 may be generated based on the multi-modal document embedding 422 and the plurality of semantic section entities 408.

In some embodiments, the multi-modal document embedding 422 is an embedding space with a plurality of co-learned embedding representations for the multi-modal document 402. For example, the multi-modal document embedding 422 may describe a common embedding space for each of the segments of the multi-modal document 402. The multi-modal document embedding 422, for example, may include a co-learned embedding representation for each text segment and/or embedded media segment within the multi-modal document 402. In some examples, the multi-modal document embedding 422 may be generated by applying a multi-modal embedding model 420 to a plurality of text features 410 and/or media features 412 of the plurality of text segments 404 and/or embedded media segments 406, such that: the multi-modal document embedding 422=multi-modal embedding model 420 (text features 410, media features 412).

In some embodiments, the plurality of text features 410 are generated for each of the one or more text segments 404 using one or more feature engineering techniques. For instance, one or more text attributes may be identified for a text segment. An enriched text segment 418 may be generated, using an NER model 416, for the text segment based on the text segment and the one or more text attributes. In some examples, the text feature 410 for the text segment may be generated based on the enriched text segment 418 and the one or more text attributes for the text segment.

In some embodiments, a text feature is a predictive characteristic of a text segment. A text feature, for example, may include one or more text attributes and/or an enriched text segment for a text segment. In some examples, a plurality of text features 410 may be encoded to generate a co-learned embedding representation for a text segment.

In some embodiments, a text attribute is a data entity that describes an observation for a text segment. A text attribute, for example, may include the content (e.g., a sequence of characters, words, sentences, etc.) of the text segment and/or one or more contextual observations, such as a page index, a location, a section title, a document title, and/or the like. By way of example, a text attribute for a text segment may include (i) a content attribute that identifies textual content of the text segment, (ii) a page index attribute that identifies a page of the multi-modal document 402 from which the text segment is extracted, (iii) a location attribute that identifies a relative location within a page of the multi-modal document 402 from which the text segment is extracted, (iv) a section title attribute that identifies a title of a semantic section entity that corresponds to the text segment, (v) a document title of the multi-modal document 402, and/or the like.

In some embodiments, an enriched text segment is a modified text segment that is modified to standardize and emphasize one or more terms within the text segment that are predictive within a prediction domain. In some examples, the enriched text segment is generated using a natural language technique, such as a NER model 416, that is configured for a particular prediction domain. As one example, in a clinical prediction domain, the enriched text segment may include one or more standardized clinical codes (e.g., International Statistical Classification of Diseases (ICD) codes, Current Procedural Terminology (CPT) codes, RxNorm codes, etc.). In some examples, an enriched text segment is generated using the NER model 416 that is trained to classify the text segment with one or more clinical codes based on the content of the text segment.

In some embodiments, the NER model 416 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The NER model 416 may include any type of model configured, trained, and/or the like to classify text with respect to a particular prediction domain, as described herein. For example, the NER model 416 may include an NLP technique, such as a machine learning model that is trained to generate a class, from a multi-class prediction space, for a text segment. By way of example, a clinical NER model 416 may include a machine learning model configured to identify and extract named entities such as diseases, medications, medical procedures, and/or the like from unstructured healthcare documents. In this manner, the process of extracting and standardizing key medical entities may be automated to help the clustering of multimodal inputs and knowledge fusion.

In some embodiments, the plurality of media feature 412 are generated for each of the one or more embedded media segment 406 using one or more feature engineering techniques. For instance, one or more media attributes may be identified for the embedded media segment 406. A textual media description 426 may be generated, using a generative model 424, for the embedded media segment 406 based on the embedded media segment 406 and the one or more media attributes. In some examples, the plurality of media features 412 are generated based on the textual media description 426 and the one or more media attributes for the embedded media segment 406.

In some embodiments, a media feature is a predictive characteristic of an embedded media segment. A media feature, for example, may include one or more media attributes and/or a textual media description for an embedded media segment. In some examples, a plurality of media features may be encoded to generate a co-learned embedding representation for an embedded media segment.

In some embodiments, a media attribute is a data entity that describes an observation for an embedded media segment. A media attribute, for example, may include the content (e.g., an image representation, etc.) of an embedded media segment and/or one or more contextual observations, such as a page index, a location, a title, a document title, and/or the like. By way of example, a media attribute for an embedded media segment may include (i) a content index attribute that identifies a location (e.g., URL, etc.) of an embedded media segment extracted from the multi-modal document 402, (ii) a page index attribute that identifies a page of the multi-modal document 402 from which the embedded media segment is extracted, (iii) a location attribute that identifies a relative location within a page of the multi-modal document 402 from which the embedded media segment is extracted, (iv) a media title attribute that identifies a textual title of the embedded media segment, (v) a document title of the multi-modal document 402, and/or the like.

In some embodiments, a textual media description includes generative text for an embedding media segment. A textual media description, for example, may include one or more media text segments that describe, in text, an embedding media segment. In some examples, a textual media description may be generated by inputting the embedded media segment to a generative model 424 that is configured to transfer the embedded media segment to a text description.

In some embodiments, a generative model 424 is a data entity that describes parameters, hyper-parameters, and/or defined operations of a rules-based and/or machine learning model (e.g., model including at least one of one or more rule-based layers, one or more layers that depend on trained parameters, coefficients, and/or the like). A generative model 424 may include any type of model configured, trained, and/or the like to generate natural language text from media, such as an embedded media segment, as described herein. For example, the generative model 424 may include an LLM, such as a GPT model. In some examples, the generative model 424 may include a GPT-4 with vision model and/or any other machine learning model with multimodal capabilities.

In some embodiments, the multi-modal document embedding 422 includes a plurality of co-learned embedding representations respectively corresponding to the one or more text segments 404 and the one or more embedded media segments 406. A multi-modal section embedding for a semantic section entity may include one or more co-learned embedding representations from the multi-modal document embedding 422 that correspond to the semantic section entity. In some examples, a plurality of multi-modal section embeddings 428 may be generated for the multi-modal document 402 through a cross-retrieval process in which the plurality of co-learned embedding representations are clustered based on their semantic relevance to each semantic section entity of the plurality of semantic section entities 408 identified within the multi-modal document 402.

In some embodiments, a co-learned embedding representation is an encoded vector that describes a segment of a multi-modal document 402. A co-learned embedding representation may be generated for a text segment and/or an embedded media segment. Each co-learned embedding representation may be generated based on one or more segment features. For instance, a co-learned embedding representation for a text segment may be generated by inputting one or more text features to the multi-modal embedding model 420. In addition, or alternatively, a co-learned embedding representation for an embedded media segment may be generated by inputting one or more media features to the multi-modal embedding model 420.

In some embodiments, the multi-modal embedding model 420 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The multi-modal embedding model 420 may include any type of model configured, trained, and/or the like to generate an intermediate output, such as a feature embedding, for a text segment, embedded media segment, and/or the like. The multi-modal embedding model 420 may include one or more of any type of machine learning model including one or more supervised, unsupervised, semi-supervised, reinforcement learning models, and/or the like. For instance, the multi-modal embedding model 420 may include a bidirectional transformer that may be configured for multi-modal data. For example, the multi-modal embedding model 420 may include a dual channel, multi-layered, neural network with a shared transformer layer. The shared transformer layer may share attention weights between intermediate representations of different modalities. In this manner, the multi-modal embedding model 420 may generate co-learned embedding representations for both text and embedded media segments within a shared embedding space.

In some embodiments, a multi-modal section embedding is generated based on a comparison between a plurality of co-learned embedding representations and a topic embedding correspond to a semantic section entity. For instance, a topic embedding may be generated, using the multi-modal embedding model 420, for a semantic section entity of the plurality of semantic section entities 408. A plurality of topic similarity scores may be generated for the plurality of co-learned embedding representations based on the topic embedding. In some examples, one or more co-learned embedding representations from the plurality of co-learned embedding representations may be identified for the semantic section entity based on the plurality of topic similarity scores. The multi-modal section embedding may be based on the one or more co-learned embedding representations.

In some embodiments, a topic embedding is an encoded vector that describes a semantic section entity. In some examples, a topic embedding may include an embedding vector that is generated, using the multi-modal embedding model 420 (and/or another embedding model), based on one or more attributes of a semantic section entity. By way of example, a topic embedding may include an embedding vector of a section title corresponding to the semantic section entity. For instance, a topic embedding may be generated by identifying a section title (e.g., based on a formatting, location, and/or the like of a text segment within the semantic section entity, etc.) for a semantic section entity and inputting the section title to the multi-modal embedding model 420, as described herein.

In some embodiments, a topic similarity score is a metric that is reflective of a semantic similarity between a semantic section entity and a segment (e.g., text segment, embedded media segment, etc.) of the multi-modal document 402. In some examples, the topic similarity score for a particular segment may be based on a comparison between a co-learned embedding representation for the particular segment and a topic embedding for a semantic section entity. For example, a topic similarity score may include an embedding-based distance metric, such as a cosine distance, and/or the like. In some examples, a plurality of segments from the multi-modal document 402 may be matched to a semantic section entity by ranking the topic similarities scores across each of the segments with respect to the semantic section entity. As described herein, the plurality of segments may be leveraged to generate a multi-modal unstructured rule 434 corresponding to the semantic section entity that fuses knowledge across multiple information modalities. For instance, the unstructured rule may be generated by applying the LLM 432 to an unstructured rule model prompt 430.

In some embodiments, one or more multi-modal unstructured rules 434 are generated based on the multi-modal section embeddings 428. For example, a multi-modal unstructured rule may be generated, using an LLM 432, for each of the plurality of semantic section entities 408 based on the plurality of multi-modal section embeddings 428. For instance, and as described herein, a multi-modal section embedding may include one or more co-learned embedding representations respectively corresponding to a text segment and an embedded media segment associated with a semantic section entity. In some examples, a multi-modal unstructured rule may be generated based on the text and media features corresponding to the text and embedded media segments associated with the semantic section entity. For instance, one or more text features for the text segment and one or more media features for the embedded media segment may be received based on the multi-modal section embedding and the multi-modal unstructured rule 434 may be generated, using the LLM 432, based on the one or more text features and the one or more media features.

In some embodiments, as described herein, the one or more text features include an enriched text segment for a text segment and the one or more media features include a textual media description for a media segment. In some examples, an unstructured rule model prompt may be generated for the LLM 432 that includes the enriched text segment, the textual media description, and an unstructured rule template. The unstructured rule model prompt may be input to generate the multi-modal unstructured rule for a semantic section entity. In some examples, the one or more multi-modal unstructured rules 434 may be generated for the multi-modal document 402 by generated and then inputting one or more unstructured rule model prompts 430 to the LLM 432 for each of the semantic section entities 408.

In some embodiments, an unstructured rule model prompt is a generative model prompt for instructing the LLM 432 to generate a multi-modal unstructured rule. In some examples, an unstructured rule model prompt may define rule criteria for a multi-modal unstructured rule, such as a character limit, a rule format, and/or the like. In some examples, the unstructured rule model prompt may include one or more prompt fields. The one or more prompt fields may include an instruction field comprising a natural language set of instructions for generating a multi-modal unstructured rule based on a second field. The second field may include a context field that provides content for generating the multi-modal unstructured rule in accordance with the set of instructions. In some examples, the context field may include an enriched text segment and/or a textual media description for each segment of the multi-modal document 402 that corresponds to a particular semantic section entity.

In some embodiments, the LLM 432 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The LLM 432 may include any type of model configured, trained, and/or the like to generate natural language text in response to a textual prompt, such as an unstructured rule model prompt, a structured rule model prompt, and/or the like. The LLM 432, for example, may include any type of LLM, such as a generative pre-trained transformer, and/or the like.

In some embodiments, a multi-modal unstructured rule is a sequence of natural language text that is output from the LLM 432 in response to an unstructured rule model prompt. The natural language text, for example, may summarize one or more portions of a context field in accordance with a natural language set of instructions.

In some embodiments, a multi-modal structured rule 442 is generated from the multi-modal unstructured rule. For example, the multi-modal structured rule 442 may be generated, using the LLM 432, for each of the plurality of semantic section entities 408 based on the multi-modal unstructured rules 434. For example, a structured rule model prompt may be generated for a semantic section entity based on the multi-modal unstructured rule, an unstructured rule template, and one or more related prompt examples 440 from an example template data store 438. In some examples, the one or more related prompt examples 440 may be identified based on a textual similarity between the multi-modal unstructured rule and a plurality of example templates from the example template data store 438. In some examples, the structured rule model prompt may be input to the LLM 432 to generate the multi-modal structured rule for the semantic section entity. In this way, a plurality of different structured rule model prompts 436 may be generated and input to the LLM 432 to generate one or more multi-modal structured rules 442 from the multi-modal document 402.

In some embodiments, a structured rule model prompt is a generative model prompt for instructing the LLM 432 to generate a multi-modal structured rule. In some examples, a structured rule model prompt may define rule criteria for a multi-modal structured rule, such as a character limit, a rule format, one or more structured fields, a structured field hierarchy (e.g., a decision tree structure, etc.), and/or the like. In some examples, the structured rule model prompt may include one or more prompt fields. The one or more prompt fields may include an instruction field comprising a natural language set of instructions for generating a multi-modal structured rule based on a second field and a third field. The second field may include a context field that provides content for generating the multi-modal unstructured rule in accordance with the set of instructions. In some examples, the context field may include a multi-modal unstructured rule for a particular semantic section entity.

In some embodiments, a third field include one or more prompt examples. For instance, a structured rule model prompt may include a few shot prompt that includes one or prompt examples that reflect ground truth outputs for the LLM 432. The one or more prompt examples may include one or more related prompt examples 440 from the example template data store 438 that correspond to the multi-modal unstructured rule for a particular semantic section entity.

In some embodiments, a related prompt example is a ground truth multi-modal structured rule for the LLM 432. The related prompt example, for instance, may include a historical multi-modal structured rule, a manually generated multi-modal structured rule, a verified multi-modal structured rule, and/or the like that is reflective of a desired format for a multi-modal structured rule generated in accordance with a structured rule model prompt. In some examples, a related prompt example may be selected from the example template data store 438 based on a semantic similarity between the related prompt example and a multi-modal unstructured rule. By way of example, a related prompt example may be selected based on an embedding distance (e.g., cosine distance, etc.) between an example embedding and a multi-modal unstructured rule. In some examples, a threshold number (e.g., five, ten, twenty, etc.) of related prompt examples may be selected from the example template data store 438 based on the semantic similarity between a multi-modal unstructured rule and a plurality of candidate prompt examples of the example template data store 438.

In some embodiments, the example template data store 438 is a data structure that describes a plurality of related prompt examples for a prediction domain. The example template data store 438 may include any type (and any number) of data storage structures including, as examples, one or more linked lists, databases (e.g., relational databases, graph database, etc.), and/or the like. In some embodiments, the example template data store 438 may include a plurality of candidate prompt examples, each reflective of a ground truth example for a multi-modal structured rule. The plurality of candidate prompt examples may include historical multi-modal structured rules, manually generated and/or verified multi-modal structured rules, and/or the like.

In some embodiments, the multi-modal structured rule refers to a text-based data structure that is output from the LLM 432 in response to a structured rule model prompt. The text-based data structure, for example, may include a structured rule set derived from a semantic section entity of the multi-modal document 402. By way of example, a text-based data structure may include a plurality of related rules that are arranged in accordance with a decision logic to improve both computer and human interpretability of a multi-modal unstructured rule. As examples, a multi-modal structured rule may include a rule-based questionnaire, decision tree logic, and/or the like that may be interacted with to provided actionable insights (e.g., binary insights, probabilities, etc.) for a particular task. In this manner, using some of the techniques of the present disclosure, the combined power of multimodal and generation capabilities may be leveraged to provide an end-to-end solution which includes both (i) understanding unstructured and complementary multi-modal content, such as traditional medical guideline documentation and (ii) distilling structured rules from the unstructured and complementary multi-modal content to improve computer comprehension for downstream tasks.

In some embodiments, the performance of a prediction-based action is initiated based on one or more multi-modal structured rules 442 extracted from a multi-modal document 402. For example, the one or more multi-modal structured rule 442 may be provided as input to one or more machine learning models and/or other downstream processes to generate a prediction, authorize an action, initiate (e.g., through control instructions to a robotic device) a physical control action, and/or the like. By way of example, by distilling actionable rule sets from traditionally undecipherable documentation, the multi-modal structured rules 442 may be input to any downstream computer process to enable automated actions in accordance with the undecipherable documentation through traversals of the multi-modal structured rules 442.

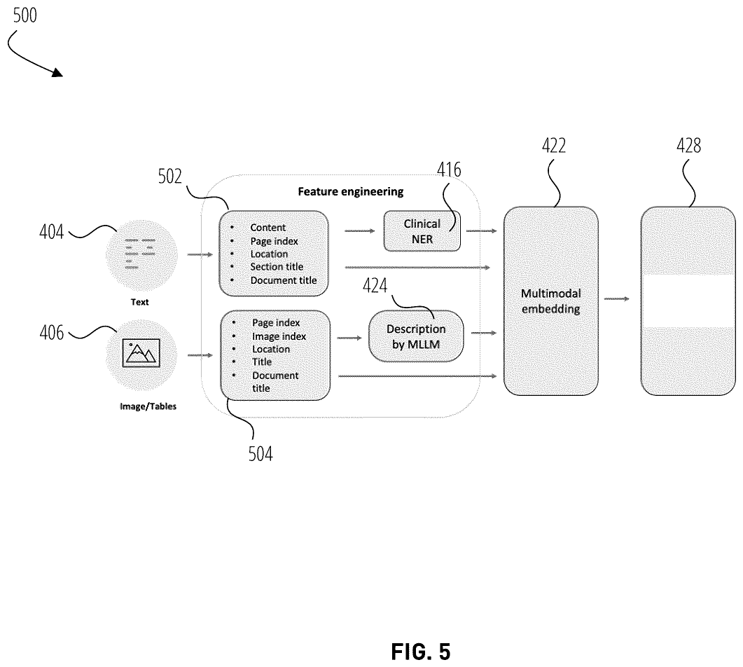

FIG. 5 is a dataflow diagram 500 showing example data structures and modules of a multi-stage feature engineering and embedding pipeline for a multi-modal embedding model in accordance with some embodiments discussed herein. As depicted, a multi-modal embedding model may generate a multi-modal document embedding 422 from a plurality of text segments 404 and embedded media segments 406 using a plurality of features engineered therefrom.

In some examples, a plurality of text attributes 502 may be extracted from the text segments 404. The text attributes 502 may be input to the NER model 416 to generate an enriched text segment, which may be input to a multi-modal embedding model to generate at least a portion of the multi-modal document embedding 422.

In some examples, a plurality of media attributes 504 may be extracted from the embedded media segments 406. The media attributes 504 may be input to the generative model 424 to generate a textual media description, which may be input to a multi-modal embedding model to generate at least a portion of the multi-modal document embedding 422.

In this manner, a multi-modal alignment process may be performed for each segment (e.g., text segment, embedded media segment, etc.) to generate a multi-modal document embedding 422 for all of the text segments 404 and the embedded media segments 406 of a multi-modal document. In some embodiments, clustering techniques may be performed to generate a plurality of multi-modal section embeddings 428 from the multi-modal document embedding 422 based on the semantic section entities of the multi-modal document.

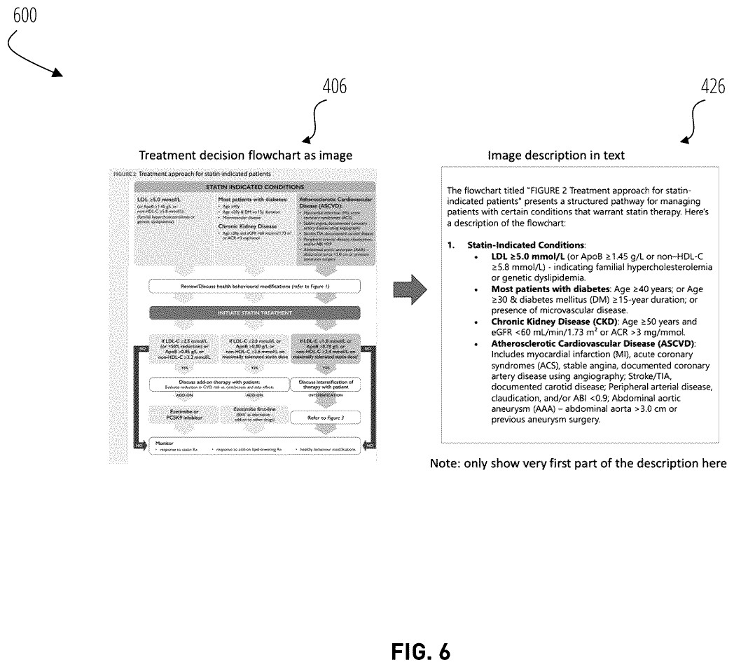

FIG. 6 is an operational example 600 of an embedded media segment and corresponding textual media description in accordance with some embodiments discussed herein. The operational example 600 illustrates an example embedded media segment 406 from a clinical guideline document. As shown, the embedded media segment 406 may include a plurality of graphical elements (e.g., arrows, boxes, etc.) that characterize text within the embedded media segment 406. The textual media description 426 includes the text from the embedded media segment 406 augmented by generative text to account for the graphical elements.

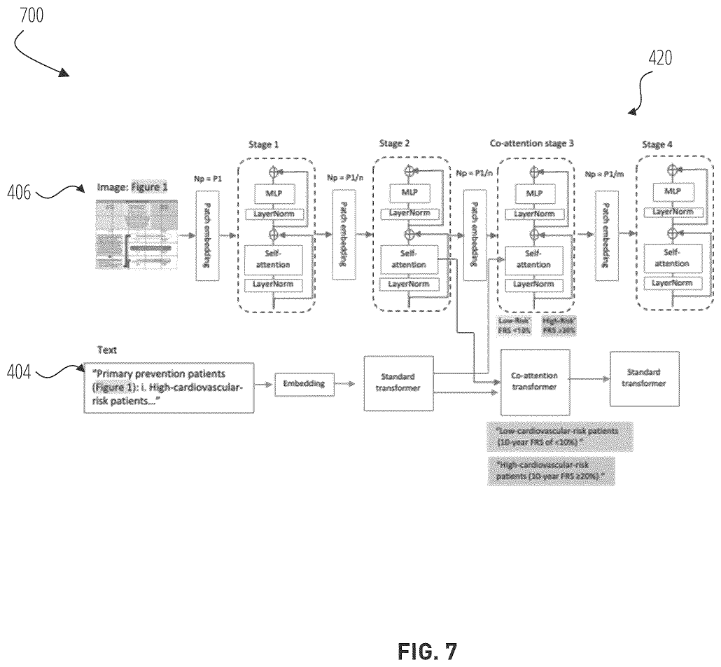

FIG. 7 is an operational example 700 of a multi-modal embedding model architecture in accordance with some embodiments discussed herein. The operational example 700 illustrates one example model architecture for a multi-modal embedding model 420. As shown, the multi-modal embedding model 420 may include multiple channels, one for each modality of a multi-modal data structure, such as the multi-modal document of the present disclosure. In the operation example 700, the multi-modal embedding model 420 may include a first channel configured to process an embedded media segment and a second channel configured to process a text segment. In some examples, the first channel may leverage a context co-learning architecture in which an embedded media segment may be processed through several patch-based embedding and transformer layers with a patch size changing from smaller to larger to learn details to a larger scale of information. The second channel may leverage a sequence of standard transformers. The multiple channels may be connected through a shared transformer layer to learn weights across different modalities. For instance, both modal transformers may include shared attention layers that may share attentions through co-attention transformers to implement a co-learning strategy. This enables the multi-modal embedding model 420 to embedded information from different modalities into a shared embedding space to achieve some of the technical advancements described herein.

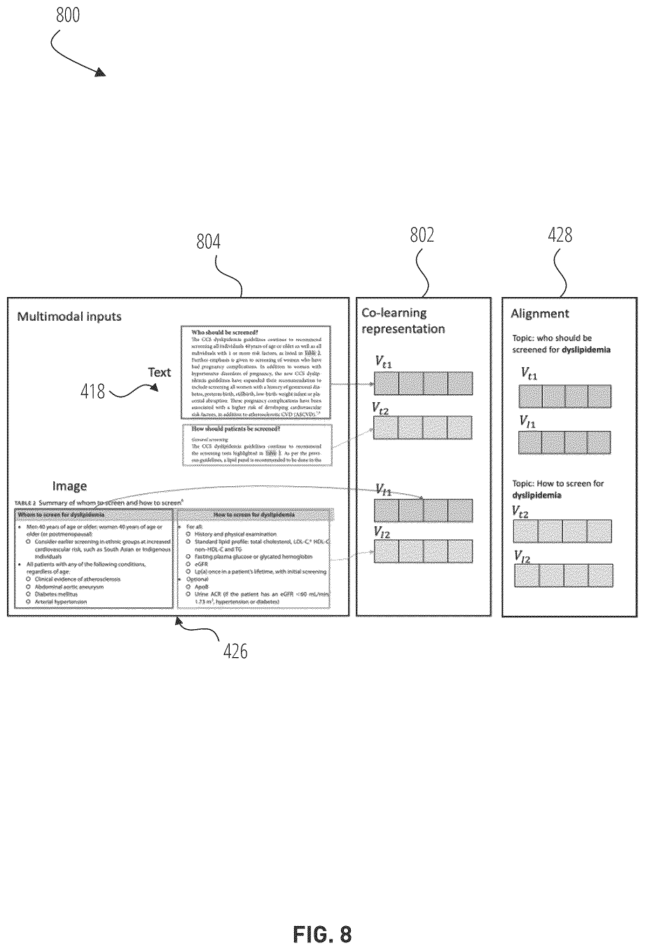

FIG. 8 is operational example 800 of a multi-modal section embedding in accordance with some embodiments discussed herein. As shown, a multi-modal section embedding 428 may be generated from one or more co-learned embedding representations 802 through an alignment of two modals. For example, co-learned embedding representations 802 may be generated from multi-modal inputs 804, including one or more enriched text segments 418 and/or textual media descriptions 426 corresponding to text segments and/or embedded media segments of a multi-modal document. The co-learned embedding representations 802 may be compared to each other, across-modalities to align textual modalities with embedded media modalities. By doing so, the co-learned embedding representation 802 of semantically related segments may be aligned to generate multi-modal section embeddings 428 for the multi-modal document.

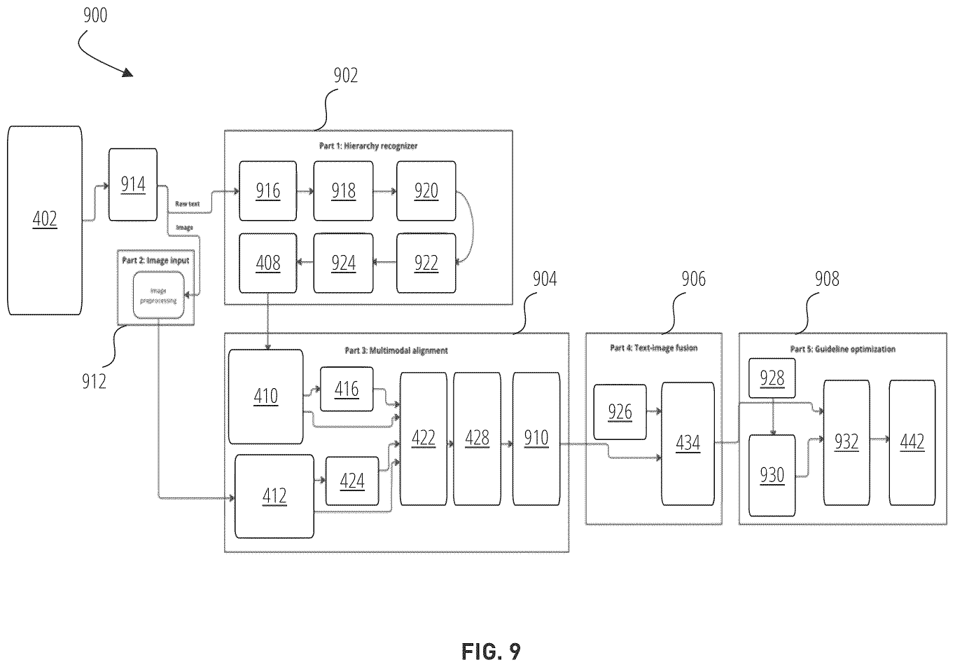

FIG. 9 is operational example 900 of the automated, end-to-end, multi-modal, data processing pipeline in accordance with some embodiments discussed herein. The operational example 900 includes a five-stage pipeline for implementing one or more techniques of the present disclosure. The operational example 900 may begin with a multi-modal document 402 and, through the five-stage pipeline, generate one or more multi-modal structured rules 442 from the multi-modal document 402. In some examples, the multi-modal document 402 may be preprocessed by a document reader 914 to extract the raw text (e.g., one or more text segments, etc.) and images (e.g., embedded media segments) from the multi-modal document 402.

At a first, hierarchy recognizer stage 902, a text format identification 916 process may be performed to extract a text format from the raw text. Thereafter, a format hierarchy analysis 918 may be performed to identify a format hierarchy based on the extracted text formats. The format hierarchy may be passed to hierarchical segmentation 920 to generate a first set of section entities. The first set of section entities may be merged through a sematic merging for adjacent segments 922 process. Finally, the merged set of section entities may be filtered through content filtering by topic hierarchy 924 to generate a plurality of semantic section entities 408 for the 402. In some examples, the output of the hierarchy recognizer stage 902 may include structured text in a dictionary.

At a second, image preprocessing stage 912, images from the multi-modal document 402 may be extracted, preprocessed to remove noise, blur, and/or other image defects, and stored with an image index for later retrieval. In some examples, the output of the image preprocessing stage 912 may include an image embedding for the images extracted from the multi-modal document 402.

At a third, multi-modal alignment stage 904, text features 410 and media features 412 may be extracted from the multi-modal document 402 and processed to generate text and image clusters that identify related text segments 910 for each semantic section entity 408 of the multi-modal document 402. For example, the text features 410 may be processed by an NER model 416 to generate an enriched text segment. The enriched text segment and the text features 410 may be processed to generate a portion of the multi-modal document embedding 422. In addition, or alternatively, the media feature 412 may be processed by a generative model 424 to generate a textual media description and the media features 412 and textual media description may be processed to generate another portion of the multi-modal document embedding 422. The multi-modal document embedding 422 may be clustered to generate multi-modal section embeddings 428 for each of the semantic section entities 408 of the multi-modal document 402 and the multi-modal section embeddings 428 may be processed to generate one or more related text segments 910 for the semantic section entities 408.

At a fourth, text-image fusion stage 906, the related text segments 910 may be leveraged, through prompt engineering 926, to generate a multi-modal unstructured rule 434 using an LLM. At the fifth, guideline optimization stage 908, the multi-modal unstructured rule 434 may be leveraged, with an instruction set 928, to perform a few shots prompt optimization 930 to generate a knowledge augmented rules generation prompt 932. The knowledge augmented rules generation prompt 932 may be provided to the LLM to generate a multi-modal structured rule 442.

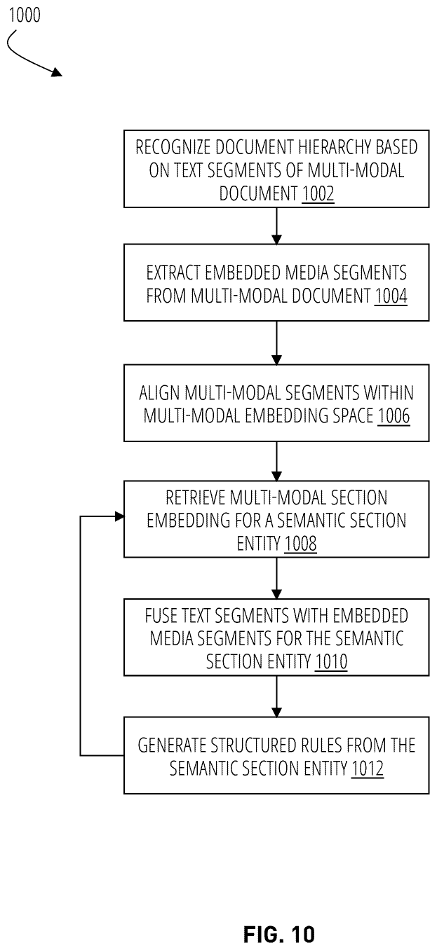

FIG. 10 is a flowchart diagram of an example process 1000 for automatically fusing multi-modal data into a comprehensive set of structured rules in accordance with some embodiments discussed herein. The flowchart depicts a multi-stage computer interpretation process 1000 for improving the performance of document processing through multi-modal knowledge transfer techniques. The process 1000 may be implemented by one or more computing devices, entities, and/or systems described herein. For example, via the various steps/operations of the process 1000, the computing system 101 may leverage improved data processing techniques to fuse insights from multiple modalities expressed within a single document. By doing so, the process 1000 facilitates computer comprehension techniques that are directly tailored to addressing technical challenges of traditional data processing technologies that are limited to a single modality.

FIG. 10 illustrates an example process 1000 for explanatory purposes. Although the example process 1000 depicts a particular sequence of steps/operations, the sequence may be altered without departing from the scope of the present disclosure. For example, some of the steps/operations depicted may be performed in parallel or in a different sequence that does not materially impact the function of the process 1000. In other examples, different components of an example device or system that implements the process 1000 may perform functions at substantially the same time or in a specific sequence.

In some embodiments, the process 1000 includes, at step/operation 1002, recognizing a document hierarchy based on text segments of a multi-modal document. For example, the computing system 101 may identify, using an NLP model, a plurality of semantic section entities from a multi-modal document based on one or more text segments within the multi-modal document.

In some embodiments, the process 1000 includes, at step/operation 1004, extracting embedded media segments from the multi-modal document. For example, the computing system 101 may identify one or more embedded media segments from the multi-modal document. In some examples, the one or more embedded media segments may include one or more of an image data structure, a table data structure, or an audio data structure.

In some embodiments, the process 1000 includes, at step/operation 1006, aligning the multi-modal segments within a multi-modal embedding space. For example, the computing system 101 may generate a plurality of text features for each of the one or more text segments, generate a plurality of media features for each of the one or more embedded media segments, and generate, using a multi-modal embedding model, a multi-modal document embedding based on the plurality of text features for each of the one or more text segments and the plurality of media features for each of the one or more embedded media segments.

In some examples, the computing system 101 may generate the plurality of text features for a text segment of the one or more text segments by identifying one or more text attributes for the text segment, generating, using a named entity recognition model, an enriched text segment for the text segment based on the text segment and the one or more text attributes; and generating the plurality of text features based on the enriched text segment and the one or more text attributes for the text segment.

In some examples, the computing system 101 may generate the plurality of media features for an embedded media segment of the one or more embedded media segment by identifying one or more media attributes for the embedded media segment, generating, using a generative model, a textual media description for the embedded media segment based on the embedded media segment and the one or more media attributes, and generating the plurality of media features based on the textual media description and the one or more media attributes for the embedded media segment.

In some examples, the multi-modal document embedding includes a plurality of co-learned embedding representations respectively corresponding to the one or more text segments and the one or more embedded media segments.

In some embodiments, the process 1000 includes, at step/operation 1008, retrieving a multi-modal section embedding for a semantic section entity. For example, the computing system 101 may generate a multi-modal section embedding for a semantic section entity of the plurality of semantic section entities based on the one or more embedded media segments and the one or more text segments. In some examples, the computing system 101 may generate the multi-modal section embedding based on the multi-modal document embedding and the plurality of semantic section entities.

In some examples, the computing system 101 may generate the multi-modal section embedding based on the multi-modal document embedding and the plurality of semantic section entities by generating, using the multi-modal embedding model, a topic embedding for a semantic section entity of the plurality of semantic section entities, generating a plurality of topic similarity scores for the plurality of co-learned embedding representations based on the topic embedding, identifying one or more co-learned embedding representations from the plurality of co-learned embedding representations based on the plurality of topic similarity scores, and generating the multi-modal section embedding based on the one or more co-learned embedding representations.

In some embodiments, the process 1000 includes, at step/operation 1010, fusing text segments with embedded media segments for the semantic section entity. For example, the computing system 101 may generate, using a large language model, a multi-modal unstructured rule based on the multi-modal section embedding. In some examples, the multi-modal section embedding includes one or more co-learned embedding representations respectively corresponding to a text segment and an embedded media segment associated with a semantic section entity. The computing system 101 may generate the multi-modal unstructured rule based on the multi-modal section embedding by receiving one or more text features for the text segment and one or more media features for the embedded media segment and generating, using the large language model, the multi-modal unstructured rule based on the one or more text features and the one or more media features.

For example, the one or more text features may include an enriched text segment for the text segment and the one or more media features may include a textual media description for the media segment. The computing system 101 may generate the multi-modal unstructured rule by generating an unstructured rule model prompt for the large language model that includes the enriched text segment, the textual media description, and an unstructured rule template and inputting the unstructured rule model prompt to the large language model to generate the multi-modal unstructured rule.

In some embodiments, the process 1000 includes, at step/operation 1012, generating structured rules from the semantic section entity. For example, the computing system 101 may generate, using the large language model, a multi-modal structured rule from the multi-modal unstructured rule. In some examples, the computing system 101 may generate the multi-modal structured rule from the multi-modal unstructured rule by generating a structured rule model prompt for the large language model that includes the multi-modal unstructured rule, an unstructured rule template, and one or more related prompt example and inputting the structured rule model prompt to the large language model to generate the multi-modal structured rule. In some examples, the one or more related prompt examples may be identified based on a textual similarity between the multi-modal unstructured rule and a plurality of example templates.

In some embodiments, the process 1000 is performed for each semantic section entity of a multi-modal document to generate a plurality of multi-modal structured rules from the document. For instance, after the performance of step/operation 1012, the process 1000 may return to step/operation 1008, where a multi-modal section embedding may be retrieved for a next semantic section entity identified within the multi-modal document.

In some embodiments, the computing system 101 initiates the performance of a prediction-based action based on the multi-modal structured rule. For example, the multi-modal structured rule may be provided to a downstream task to implement one or more automated processes in accordance with the multi-modal document.

In this way, some techniques of the present disclosure enable the generation of action outputs that may be performed to initiate one or more real world actions to achieve real-world effects. The data processing techniques of the present disclosure may be used, applied, and/or otherwise leveraged to generate multi-modal structured rules, which may help in the creation and provisioning of messages across computing entities, as well as other downstream tasks. For instance, a multi-modal structured rule, using some of the techniques of the present disclosure, may trigger the performance of actions at a client device, such as the display, transmission, and/or the like of data reflective of multi-modal structured rule. In some embodiments, the multi-modal structured rule may be applied to one or more inputs to identify an anomalous condition, trigger an alert, and/or the like. The alert may be automatically communicated to a user associated with the anomalous condition. In addition, or alternatively, the multi-modal structured rule may trigger a physical action, such as a movement of a robotic device, and/or the like to address an anomalous condition in accordance with the multi-modal document.

In some examples, the computing tasks may include actions that may be based on a particular prediction domain, such as the clinical domain used as an example herein. A prediction domain may include any environment in which computing systems may be applied to interpret and generate instruction sets from multi-modal documents and initiate the performance of computing tasks responsive to the instruction sets. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, and/or the like.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising identifying, by one or more processors and using a natural language processing model, a plurality of semantic section entities from a multi-modal document based on one or more text segments within the multi-modal document; identifying, by the one or more processors, one or more embedded media segments from the multi-modal document; generating, by the one or more processors, a multi-modal section embedding for a semantic section entity of the plurality of semantic section entities based on the one or more embedded media segments and the one or more text segments; generating, by the one or more processors and using a large language model, a multi-modal unstructured rule based on the multi-modal section embedding; generating, by the one or more processors and using the large language model, a multi-modal structured rule from the multi-modal unstructured rule; and initiating, by the or more processors, the performance of a prediction-based action based on the multi-modal structured rule.

Example 2. The computer-implemented method of example 1, wherein the one or more embedded media segments comprise one or more of an image data structure, a table data structure, or an audio data structure.

Example 3. The computer-implemented method of any of the preceding examples, wherein generating the multi-modal section embedding comprises generating a plurality of text features for each of the one or more text segments; generating a plurality of media features for each of the one or more embedded media segments; generating, using a multi-modal embedding model, a multi-modal document embedding based on the plurality of text features for each of the one or more text segments and the plurality of media features for each of the one or more embedded media segments; and generating the multi-modal section embedding based on the multi-modal document embedding and the plurality of semantic section entities.

Example 4. The computer-implemented method of example 3, wherein generating the plurality of text features for a text segment of the one or more text segments comprises identifying one or more text attributes for the text segment; generating, using a named entity recognition model, an enriched text segment for the text segment based on the text segment and the one or more text attributes; and generating the plurality of text features based on the enriched text segment and the one or more text attributes for the text segment.

Example 5. The computer-implemented method of examples 3 or 4, wherein generating the plurality of media features for an embedded media segment of the one or more embedded media segments comprises identifying one or more media attributes for the embedded media segment; generating, using a generative model, a textual media description for the embedded media segment based on the embedded media segment and the one or more media attributes; and generating the plurality of media features based on the textual media description and the one or more media attributes for the embedded media segment.

Example 6. The computer-implemented method of any of examples 3 through 5, wherein the multi-modal document embedding comprises a plurality of co-learned embedding representations respectively corresponding to the one or more text segments and the one or more embedded media segments.

Example 7. The computer-implemented method of example 6, wherein generating the multi-modal section embedding based on the multi-modal document embedding and the plurality of semantic section entities comprises generating, using the multi-modal embedding model, a topic embedding for the semantic section entity of the plurality of semantic section entities; generating a plurality of topic similarity scores for the plurality of co-learned embedding representations based on the topic embedding; identifying one or more co-learned embedding representations from the plurality of co-learned embedding representations based on the plurality of topic similarity scores; and generating the multi-modal section embedding based on the one or more co-learned embedding representations.

Example 8. The computer-implemented method of any of the preceding examples, wherein the multi-modal section embedding comprises one or more co-learned embedding representations respectively corresponding to a text segment and an embedded media segment associated with the semantic section entity, and generating the multi-modal unstructured rule based on the multi-modal section embedding comprises receiving one or more text features for the text segment and one or more media features for the embedded media segment; and generating, using the large language model, the multi-modal unstructured rule based on the one or more text features and the one or more media features.

Example 9. The computer-implemented method of example 8, wherein the one or more text features comprises an enriched text segment for the text segment, the one or more media features comprises a textual media description for the embedded media segment, and generating the multi-modal unstructured rule comprises generating an unstructured rule model prompt for the large language model that comprises the enriched text segment, the textual media description, and an unstructured rule template; and inputting the unstructured rule model prompt to the large language model to generate the multi-modal unstructured rule.

Example 10. The computer-implemented method of any of the preceding examples, wherein generating the multi-modal structured rule from the multi-modal unstructured rule comprises generating a structured rule model prompt for the large language model that comprises the multi-modal unstructured rule, an unstructured rule template, and one or more related prompt examples; and inputting the structured rule model prompt to the large language model to generate the multi-modal structured rule.

Example 11. The computer-implemented method of example 10, wherein the one or more related prompt examples are identified based on a textual similarity between the multi-modal unstructured rule and a plurality of example templates.

Example 12. A computing system comprising memory and one or more processors communicatively coupled to the memory, the one or more processors configured to identify, using a natural language processing model, a plurality of semantic section entities from a multi-modal document based on one or more text segments within the multi-modal document; identify one or more embedded media segments from the multi-modal document; generate a multi-modal section embedding for a semantic section entity of the plurality of semantic section entities based on the one or more embedded media segments and the one or more text segments; generate, using a large language model, a multi-modal unstructured rule based on the multi-modal section embedding; generate, using the large language model, a multi-modal structured rule from the multi-modal unstructured rule; and initiate the performance of a prediction-based action based on the multi-modal structured rule.

Example 13. The computing system of example 12, wherein the one or more embedded media segments comprise one or more of an image data structure, a table data structure, or an audio data structure.

Example 14. The computing system of example 12, wherein generating the multi-modal section embedding comprises generating a plurality of text features for each of the one or more text segments; generating a plurality of media features for each of the one or more embedded media segments; generating, using a multi-modal embedding model, a multi-modal document embedding based on the plurality of text features for each of the one or more text segments and the plurality of media features for each of the one or more embedded media segments; and generating the multi-modal section embedding based on the multi-modal document embedding and the plurality of semantic section entities.

Example 15. The computing system of example 14, wherein generating the plurality of text features for a text segment of the one or more text segments comprises identifying one or more text attributes for the text segment; generating, using a named entity recognition model, an enriched text segment for the text segment based on the text segment and the one or more text attributes; and generating the plurality of text features based on the enriched text segment and the one or more text attributes for the text segment.

Example 16. The computing system of examples 14 or 15, wherein generating the plurality of media features for an embedded media segment of the one or more embedded media segments comprises identifying one or more media attributes for the embedded media segment; generating, using a generative model, a textual media description for the embedded media segment based on the embedded media segment and the one or more media attributes; and generating the plurality of media features based on the textual media description and the one or more media attributes for the embedded media segment.

Example 17. The computing system of any of examples 14 through 16, wherein the multi-modal document embedding comprises a plurality of co-learned embedding representations respectively corresponding to the one or more text segments and the one or more embedded media segments.

Example 18. The computing system of example 17, wherein generating the multi-modal section embedding based on the multi-modal document embedding and the plurality of semantic section entities comprises generating, using the multi-modal embedding model, a topic embedding for the semantic section entity of the plurality of semantic section entities; generating a plurality of topic similarity scores for the plurality of co-learned embedding representations based on the topic embedding; identifying one or more co-learned embedding representations from the plurality of co-learned embedding representations based on the plurality of topic similarity scores; and generating the multi-modal section embedding based on the one or more co-learned embedding representations.

Example 19. One or more non-transitory computer-readable storage media including instructions that, when executed by one or more processors, cause the one or more processors to identify, using a natural language processing model, a plurality of semantic section entities from a multi-modal document based on one or more text segments within the multi-modal document; identify one or more embedded media segments from the multi-modal document; generate a multi-modal section embedding for a semantic section entity of the plurality of semantic section entities based on the one or more embedded media segments and the one or more text segments; generate, using a large language model, a multi-modal unstructured rule based on the multi-modal section embedding; generate, using the large language model, a multi-modal structured rule from the multi-modal unstructured rule; and initiate the performance of a prediction-based action based on the multi-modal structured rule.

Example 20. The one or more non-transitory computer-readable storage media of example 19, wherein the multi-modal section embedding comprises one or more co-learned embedding representations respectively corresponding to a text segment and an embedded media segment associated with the semantic section entity, and generating the multi-modal unstructured rule based on the multi-modal section embedding comprises receiving one or more text features for the text segment and one or more media features for the embedded media segment; and generating, using the large language model, the multi-modal unstructured rule based on the one or more text features and the one or more media features.

Example 21. The computer-implemented method of example 1, wherein the multi-modal embedding model comprises a dual channel, multi-layered, neural network with a shared transformer layer and the computer-implemented method further comprises receiving training data for the multi-modal embedding model, wherein the training data comprises a domain-specific, multi-modal training dataset; and training the multi-modal embedding model using the training data.

Example 22: The computer-implemented method of example 21, wherein the training is performed by the one or more processors.

Example 23: The computer-implemented method of example 21, wherein the one or more processors are included in a first computing entity; and the training is performed by one or more other processors included in a second computing entity.

Example 24. The computing system of example 11, wherein the multi-modal embedding model comprises a dual channel, multi-layered, neural network with a shared transformer layer and the one or more processors are further configured to receive training data for the multi-modal embedding model, wherein the training data comprises a domain-specific, multi-modal training dataset; and train the multi-modal embedding model using the training data.

Example 25: The computing system of example 24, wherein the training is performed by the one or more processors.

Example 26: The computing system of example 24, wherein the one or more processors are included in a first computing entity; and the training is performed by one or more other processors included in a second computing entity.

Example 27. The one or more non-transitory computer-readable storage media of example 18, wherein the multi-modal embedding model comprises a dual channel, multi-layered, neural network with a shared transformer layer and the one or more processors are further configured to receive training data for the multi-modal embedding model, wherein the training data comprises a domain-specific, multi-modal training dataset; and train the multi-modal embedding model using the training data.

Example 28: The one or more non-transitory computer-readable storage media of example 27, wherein the training is performed by the one or more processors.

Example 29: The one or more non-transitory computer-readable storage media of example 27, wherein the one or more processors are included in a first computing entity; and the training is performed by one or more other processors included in a second computing entity.

1. A computer-implemented method comprising:
identifying, by one or more processors and using a natural language processing model, a plurality of semantic section entities from a multi-modal document based on one or more text segments within the multi-modal document;
identifying, by the one or more processors, one or more embedded media segments from the multi-modal document;
generating, by the one or more processors, a multi-modal section embedding for a semantic section entity of the plurality of semantic section entities based on the one or more embedded media segments and the one or more text segments;
generating, by the one or more processors and using a large language model, a multi-modal unstructured rule based on the multi-modal section embedding;
generating, by the one or more processors and using the large language model, a multi-modal structured rule from the multi-modal unstructured rule; and
initiating, by the or more processors, the performance of a prediction-based action based on the multi-modal structured rule.

2. The computer-implemented method of claim 1, wherein the one or more embedded media segments comprise one or more of an image data structure, a table data structure, or an audio data structure.

3. The computer-implemented method of claim 1, wherein generating the multi-modal section embedding comprises:
generating a plurality of text features for each of the one or more text segments;
generating a plurality of media features for each of the one or more embedded media segments;
generating, using a multi-modal embedding model, a multi-modal document embedding based on the plurality of text features for each of the one or more text segments and the plurality of media features for each of the one or more embedded media segments; and
generating the multi-modal section embedding based on the multi-modal document embedding and the plurality of semantic section entities.

4. The computer-implemented method of claim 3, wherein generating the plurality of text features for a text segment of the one or more text segments comprises:
identifying one or more text attributes for the text segment;
generating, using a named entity recognition model, an enriched text segment for the text segment based on the text segment and the one or more text attributes; and
generating the plurality of text features based on the enriched text segment and the one or more text attributes for the text segment.

5. The computer-implemented method of claim 3, wherein generating the plurality of media features for an embedded media segment of the one or more embedded media segments comprises:
identifying one or more media attributes for the embedded media segment;
generating, using a generative model, a textual media description for the embedded media segment based on the embedded media segment and the one or more media attributes; and
generating the plurality of media features based on the textual media description and the one or more media attributes for the embedded media segment.

6. The computer-implemented method of claim 3, wherein the multi-modal document embedding comprises a plurality of co-learned embedding representations respectively corresponding to the one or more text segments and the one or more embedded media segments.

7. The computer-implemented method of claim 6, wherein generating the multi-modal section embedding based on the multi-modal document embedding and the plurality of semantic section entities comprises:
generating, using the multi-modal embedding model, a topic embedding for the semantic section entity of the plurality of semantic section entities;
generating a plurality of topic similarity scores for the plurality of co-learned embedding representations based on the topic embedding;
identifying one or more co-learned embedding representations from the plurality of co-learned embedding representations based on the plurality of topic similarity scores; and
generating the multi-modal section embedding based on the one or more co-learned embedding representations.

8. The computer-implemented method of claim 1, wherein the multi-modal section embedding comprises one or more co-learned embedding representations respectively corresponding to a text segment and an embedded media segment associated with the semantic section entity, and generating the multi-modal unstructured rule based on the multi-modal section embedding comprises:
receiving one or more text features for the text segment and one or more media features for the embedded media segment; and
generating, using the large language model, the multi-modal unstructured rule based on the one or more text features and the one or more media features.

9. The computer-implemented method of claim 8, wherein the one or more text features comprises an enriched text segment for the text segment, the one or more media features comprises a textual media description for the embedded media segment, and generating the multi-modal unstructured rule comprises:
generating an unstructured rule model prompt for the large language model that comprises the enriched text segment, the textual media description, and an unstructured rule template; and
inputting the unstructured rule model prompt to the large language model to generate the multi-modal unstructured rule.

10. The computer-implemented method of claim 1, wherein generating the multi-modal structured rule from the multi-modal unstructured rule comprises:
generating a structured rule model prompt for the large language model that comprises the multi-modal unstructured rule, an unstructured rule template, and one or more related prompt examples; and
inputting the structured rule model prompt to the large language model to generate the multi-modal structured rule.

11. The computer-implemented method of claim 10, wherein the one or more related prompt examples are identified based on a textual similarity between the multi-modal unstructured rule and a plurality of example templates.

12. A computing system comprising memory and one or more processors communicatively coupled to the memory, the one or more processors configured to:
identify, using a natural language processing model, a plurality of semantic section entities from a multi-modal document based on one or more text segments within the multi-modal document;
identify one or more embedded media segments from the multi-modal document;
generate a multi-modal section embedding for a semantic section entity of the plurality of semantic section entities based on the one or more embedded media segments and the one or more text segments;
generate, using a large language model, a multi-modal unstructured rule based on the multi-modal section embedding;
generate, using the large language model, a multi-modal structured rule from the multi-modal unstructured rule; and
initiate the performance of a prediction-based action based on the multi-modal structured rule.

13. The computing system of claim 12, wherein the one or more embedded media segments comprise one or more of an image data structure, a table data structure, or an audio data structure.

14. The computing system of claim 12, wherein generating the multi-modal section embedding comprises:
generating a plurality of text features for each of the one or more text segments;
generating a plurality of media features for each of the one or more embedded media segments;
generating, using a multi-modal embedding model, a multi-modal document embedding based on the plurality of text features for each of the one or more text segments and the plurality of media features for each of the one or more embedded media segments; and
generating the multi-modal section embedding based on the multi-modal document embedding and the plurality of semantic section entities.

15. The computing system of claim 14, wherein generating the plurality of text features for a text segment of the one or more text segments comprises:
identifying one or more text attributes for the text segment;
generating, using a named entity recognition model, an enriched text segment for the text segment based on the text segment and the one or more text attributes; and
generating the plurality of text features based on the enriched text segment and the one or more text attributes for the text segment.

16. The computing system of claim 14, wherein generating the plurality of media features for an embedded media segment of the one or more embedded media segments comprises:
identifying one or more media attributes for the embedded media segment;
generating, using a generative model, a textual media description for the embedded media segment based on the embedded media segment and the one or more media attributes; and
generating the plurality of media features based on the textual media description and the one or more media attributes for the embedded media segment.

17. The computing system of claim 14, wherein the multi-modal document embedding comprises a plurality of co-learned embedding representations respectively corresponding to the one or more text segments and the one or more embedded media segments.

18. The computing system of claim 17, wherein generating the multi-modal section embedding based on the multi-modal document embedding and the plurality of semantic section entities comprises:
generating, using the multi-modal embedding model, a topic embedding for the semantic section entity of the plurality of semantic section entities;
generating a plurality of topic similarity scores for the plurality of co-learned embedding representations based on the topic embedding;
identifying one or more co-learned embedding representations from the plurality of co-learned embedding representations based on the plurality of topic similarity scores; and
generating the multi-modal section embedding based on the one or more co-learned embedding representations.

19. One or more non-transitory computer-readable storage media including instructions that, when executed by one or more processors, cause the one or more processors to:
identify, using a natural language processing model, a plurality of semantic section entities from a multi-modal document based on one or more text segments within the multi-modal document;
identify one or more embedded media segments from the multi-modal document;
generate a multi-modal section embedding for a semantic section entity of the plurality of semantic section entities based on the one or more embedded media segments and the one or more text segments;
generate, using a large language model, a multi-modal unstructured rule based on the multi-modal section embedding;
generate, using the large language model, a multi-modal structured rule from the multi-modal unstructured rule; and
initiate the performance of a prediction-based action based on the multi-modal structured rule.

20. The one or more non-transitory computer-readable storage media of claim 19, wherein the multi-modal section embedding comprises one or more co-learned embedding representations respectively corresponding to a text segment and an embedded media segment associated with the semantic section entity, and generating the multi-modal unstructured rule based on the multi-modal section embedding comprises:
receiving one or more text features for the text segment and one or more media features for the embedded media segment; and
generating, using the large language model, the multi-modal unstructured rule based on the one or more text features and the one or more media features.
